(19) United States
(12) Patent Application Publication
(10) Pub. No.: US 2026/0277630 A1
(43) Pub. Date: Sep. 17, 2026

(54) ARTIFICIAL INTELLIGENCE-BASED USER INTERFACE PRESENTATION

(71) Applicants: Sony Interactive Entertainment Inc., Tokyo (JP); Sony Interactive Entertainment LLC, San Mateo, CA (US)

(72) Inventors: Jeffrey R. Stafford, Redwood City, CA (US); Joseph Logan Olson, Glendale, CA (US); Nathan Gross, Aliso Viejo, CA (US); Bandaly Azzam, Anaheim Hills, CA (US); Roelof Roderick Colenbrander, Costa Mesa, CA (US)

(73) Assignees: Sony Interactive Entertainment Inc., Tokyo (JP); Sony Interactive Entertainment LLC, San Mateo, CA (US)

(21) Appl. No.: 19/080,213

(22) Filed: Mar. 14, 2025

(51) Int. Cl. G06F 9/451

(52) U.S. Cl. CPC G06F 9/451

(57) ABSTRACT

Techniques for artificial intelligence (AI)-based user interface presentation are described. In an example, a computer system executes an application remotely from a device. The application has a first graphical user interface (GUI) that can be presented at the device. The computer system generates an input to an AI model based on the first GUI and a user input to the application at the device. The computer system receives, from the AI model and based on the input, an output indicating a second GUI that has at least one function of the application common with the first GUI. The computer system causes the device to present the second GUI based on the output.

### BACKGROUND

A software application can be executed on a cloud server that is remote from a client device where a user interface of the software application is presented. Inputs are transmitted from the client device over the Internet to the cloud executed application, and results of the inputs are generated by the application and streamed over the Internet to the client device for rendering on a display.

For video game applications, a game console helps to streamline the gaming industry by providing a common platform of standardized resources (e.g., hardware and software) for the development, distribution, and execution of video games. In this manner, game developers can optimize their game development for the game console, and provide consumers with a seamless video game experience devoid of concerns about video game compatibility, optimization, or complicated setup with respect to the platform on which the game is run.

### BRIEF DESCRIPTION OF THE DRAWINGS

Features, embodiments, and advantages of the present disclosure are better understood when the following Detailed Description is read with reference to the accompanying drawings.

FIG. 1 illustrates an example computing environment for cloud game development using artificial intelligence-based user interface presentation, according to an embodiment of the present disclosure.

FIG. 2 illustrates an example of replicating an entirety of a graphical user interface locally, according to an embodiment of the present disclosure.

FIG. 3 illustrates an example of replicating a portion of a graphical user interface locally, according to an embodiment of the present disclosure.

FIG. 4 illustrates an example of rearranging a graphical user interface locally, according to an embodiment of the present disclosure.

FIG. 5 illustrates an example flow for artificial intelligence-based user interface presentation, according to an embodiment of the present disclosure.

FIG. 6 illustrates another example computing environment for cloud game development using artificial intelligence-based user interface presentation, according to an embodiment of the present disclosure.

FIG. 7 illustrates an example of a hardware system suitable for implementing a computer system, according to embodiments of the present disclosure.

In the appended figures, similar components and/or features may have the same reference label.

### DETAILED DESCRIPTION OF THE INVENTION

In the following description, for the purposes of explanation, specific details are set forth in order to provide a thorough understanding of certain embodiments. However, it will be apparent that various embodiments may be practiced without these specific details. The figures and description are not intended to be restrictive. The word “exemplary” is used herein to mean “serving as an example, instance, or illustration.” Any embodiment or design described herein as “exemplary” is not necessarily to be construed as preferred or advantageous over other embodiments or designs.

Embodiments of the present disclosure are directed to, among other things, artificial intelligence (AI)-based user interface presentation. A user can use a local device to interact with an application on a remote computer system, and rather than using the user interface directly, a multimodal AI model can generate an ad hoc interface on the local device. The multimodal model can generate the ad hoc interface based on the remote user interface and can turn it into structured inputs/outputs for the interface. When the user interacts with the local user interface, the device can send events (e.g., mouse clicks, keyboard entries, etc.) to the remote computer system. The multimodal model can then generate outputs to operate the remote computer directly or can use a programmatic interface.

In an example, a computer system, such as a cloud server system, executes an application remotely from a device. The application can have a first graphical user interface (GUI) that can be presented at the device. The computer system generates an input to an AI model based on the first GUI and a user input to the application at the device. The computer system receives, from the AI model and based on the input, an output indicating a second GUI that has a function of the application common with the first GUI. The computer system then causes the device to present the second GUI based on the output. So, the second GUI may include a same or different set of GUI elements for the common function as the first GUI.

To illustrate, consider the following particular example. There is a first game developer and a second game developer that are using an application for game developing. The first game developer is an artist, and the second game developer is a coder. The application is executed by a cloud server system that is remote from a first client device of the artist and a second client device of the coder. The application has a first GUI that has functions for artists and for coders, but there is no benefit of presenting GUI elements related to artist development to the coder and vice versa. So, for the artist, depending on what is being currently presented to the artist and their user inputs, an AI model generates a second GUI. Similarly, for the coder, depending on what is being currently presented to the coder and their user inputs, the AI model generates a third GUI. The second GUI is presented at the first client device instead of first GUI, and the third GUI is presented at the second client device instead of first GUI.

Thus, rather than transferring irrelevant GUI elements of the first GUI as-is to the client devices, for the artist, the cloud server system can instead use the AI model to generate an output corresponding to the second GUI that can be presented at the first client device. The AI model can receive a screenshot of the first GUI that includes the functions for the artists and the coders, as well as a user input indicating that the artist is working on a painting that is to be displayed in a museum in the game. Based on the input, the AI model can generate the output that indicates the second GUI, where the second GUI only includes GUI elements related to creating the painting, while excluding GUI elements for other aspects such as code development. The cloud server system sends the output of the AI model to the first client device, which presents the second GUI for creating the painting. Because the second GUI lacks some of the functions and GUI elements of the first GUI, presenting the second GUI and subsequent actions at the second GUI may be more responsive and occur with less latency particularly related to displaying visuals.

Embodiments of the present disclosure can provide several advantages over existing techniques in cloud gaming development. Conventional techniques may involve interacting with a local user interface of a client device to interact with an application on a remote computer system. When using software remotely, the latency of the interactions and updating of the user interface may be high between the client device and the remote computer system. In addition, the user interface may be more complicated than necessary for a particular user or task. By using an AI model to generate a second user interface that corresponds to at least a portion of the application and that can be presented at the client device, embodiments described herein can significantly reduce latency involved in interacting with the application on the remote computer system. Since streaming data for visuals can significantly contribute to the latency, by not streaming the data for visuals (or only streaming a portion of the data) and only sending data necessary to create a GUI element, the latency is reduced. In addition, the client device may consume fewer computing resources by rendering GUIs that involve fewer GUI elements than usual.

Although aspects herein are described in relation to development of video game applications, embodiments are not limited as such. For example, embodiments may similarly apply to other areas such as cloud-based video gaming, remote desktop, screen mirroring, screen sharing, etc.

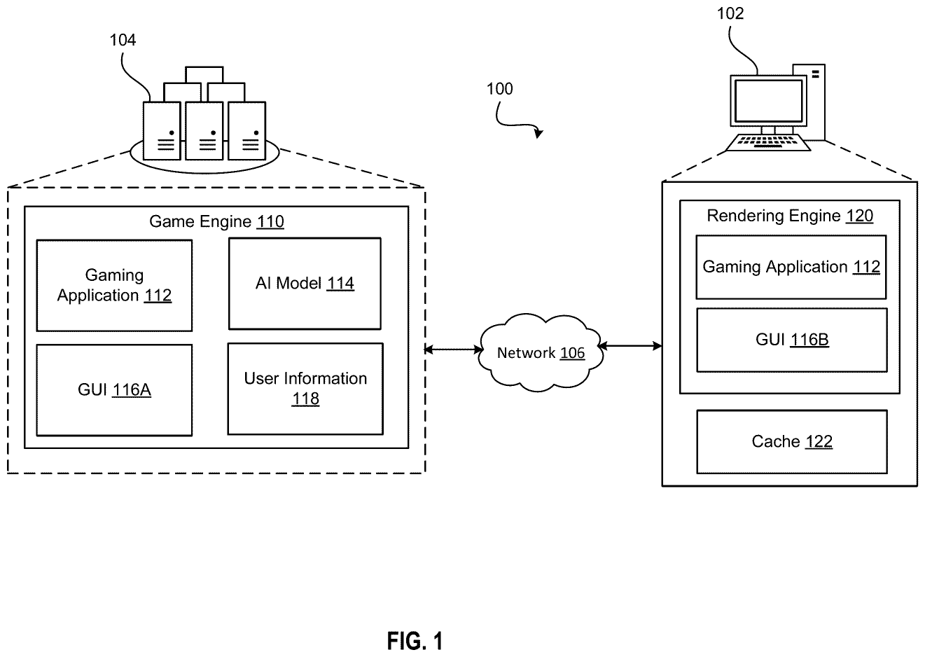

FIG. 1 illustrates an example computing environment for cloud game development using artificial intelligence-based user interface presentation, according to an embodiment of the present disclosure. The computing environment 100 can include a client device 102 and a cloud server system 104 communicatively coupled via a wireless network 106 (e.g., the Internet). The cloud server system 104 can host a gaming application 112 via a game engine 110. An example of the game engine 110 can be Unreal® Engine. The gaming application 112 may be in development. For example, the client device 102 may be used to access portions of the gaming application 112, such as by modifying or adding code to the gaming application 112. To do so, the client device 102 may download a copy of some or all of the gaming application 112 from the cloud server system 104 via the network 106. The client device 102 may modify the gaming application 112 and then upload modified features of the gaming application 112 back to the cloud server system 104.

The cloud server system 104 includes a processor and a memory (e.g., a non-transitory computer-readable storage medium) storing computer-readable instructions that can be executed by the processor and that, upon execution by the processor, cause the cloud server system 104 to perform operations related to various applications. In particular, the computer-readable instructions can correspond to program codes for the various applications of the game engine 110 including the gaming application 112 and artificial intelligence (AI) model 114. A video game application, such as gaming application 112, generally represents a computer application executable to present video game content, receive user interaction with the video game content, and accordingly update the video game content. Further, other applications can be likewise included in cloud server system 104.

The client device 102 also includes a processor and a memory (e.g., a non-transitory computer-readable storage medium) storing computer-readable instructions that can be executed by the processor and that, upon execution by the processor, cause the client device 102 to perform operations related to various applications. In particular, the computer-readable instructions can correspond to program codes for the various applications of the rendering engine 120. The client device 102 may execute the rendering engine 120 to render the transferred and downloaded data files into a presentation of the gaming application 112. In some examples, the rendering engine 120 may be the same engine as the game engine 110 hosted by the cloud server system 104. In other examples, the rendering engine 120 may be any engine that can render the GUI elements of at least a portion of the gaming application 112.

In an example, the cloud server system 104 can execute the gaming application 112 remotely from the client device 102. The gaming application 112 has a graphical user interface (GUI) 116A that can be presented at the client device 102. The cloud server system 104 can generate an input to the AI model 114 based on the GUI 116A and a user input to the gaming application 112. The AI model 114 can be a large multimodal model such as Claude or GPT4 that can receive a multimodal input. The AI model 114 may be an off-the-shelf model that is finetuned on a dataset of computer actions or by using reinforcement learning with a simulated environment and rewards for achieving a task. For example, the input based on the GUI 116A may include a screenshot or other image of a current state of the GUI 116A. The user input to the gaming application 112 may involve keyboard entries or mouse clicks (e.g., button selections, slider drags, etc.) received by the gaming application 112. The input may additionally or alternatively be based on structured data including, but not limited to, Hypertext Markup Language (HTML) data, JavaScript data, or JavaScript object notation (JSON) data objects. Upon receiving the user input, the client device 102 may locally render a cursor shape (e.g., an hourglass) indicating that an action associated with the user input is being processed. In some instances, the input to the AI model 114 can also include exposed application programming interface (API) information for the gaming application 112 or code (e.g., extensible markup language (XML) or JSON) indicating a portion of the gaming application 112 being interacted with.

The cloud server system 104 receives an output from the AI model 114 that is generated based on the input. The output can indicate a GUI 116B that has at least one function of the gaming application 112 common with the GUI 116A. The output can include two-dimensional textual data such as HTML data with Cascading Style Sheets (CSS) data for the GUI 116B. The output may additionally or alternatively include JavaScript data or GUI information as structured data such as JSON objects. In an example, the GUI 116A may include a set of GUI elements (e.g., text, buttons, menus, tabs, images, icons, sliders, etc.) that corresponds to the common function. So, the output can indicate that the GUI 116B is to include one or more GUI elements of the set of GUI elements corresponding to the common function. A GUI element of the GUI 116B that corresponds to the function may be similar or different to the GUI element of the GUI 116A that corresponds to the function. For example, the GUI element of the GUI 116B may be a different size, shape, font, etc. compared to the GUI element of the GUI 116A.

The cloud server system 104 can cause the client device 102 to present the GUI 116B based on the output. For example, the cloud server system 104 can send the HTML data with the CSS data to the client device 102, and the client device 102 can reinterpret the two-dimensional textual data into the GUI 116B, which is presented at the client device 102. The client device 102 may use a mapping between the output and the arrangement of the GUI 116A to present the GUI 116B. As such, the GUI 116B represents a real-time local interface that corresponds to the GUI 116A, even though an entirety of the GUI 116A may not be replicated or otherwise represented by the GUI 116B. In the case that the AI model 114 generates structured data as the output, the client device 102 can receive the structured data and interpret the structured data to generate the GUI 116B. For example, based on a JSON object describing GUI information (e.g., what buttons are present, where the buttons are located, etc.), the client device 102 can generate the GUI 116B.

In an example, the output of the AI model 114 may be generated based on user information 118, which may be included in the input to the AI model 114. The user information 118 may provide one or more of access permissions, a profile, or user settings associated with a user of the client device 102. For example, the access permissions may specify functions of the GUI 116A that the user is permitted and prohibited to access. So, the output that indicates the GUI 116B can exclude GUI elements of the GUI 116A that correspond to functions that the user is prohibited from accessing. In addition, the user may configure user settings indicating a set of GUI elements of the GUI 116A and an arrangement of the GUI elements that are to be provided by the GUI 116B. So, the output can indicate the set of GUI elements and their arrangement for the GUI 116B while excluding other GUI elements of the GUI 116A based on the user settings. As such, the GUI 116B is customizable based on the user. So, for another client device associated with a different user that is executing the gaming application 112 remotely, the AI model 114 can generate another output indicating an additional GUI that has the common function of the GUI 116A and is presented at the other client device, where the additional GUI is different from the GUI 116B.

Because some GUI elements, such as drop-down menus, of the GUI 116A may not be visible in the screenshot that is input to the AI model 114, the AI model 114 may perform a scraping operation of the gaming application 112 to crawl through the execution of the gaming application 112 on the cloud server system 104. The AI model 114 can then output a set of GUI elements associated with the gaming application 112 and can cache the set of GUI elements for generating a portion of the GUI 116B that includes a GUI element that is not visible in the GUI 116A.

The AI model 114 may also be able to predict a subsequent GUI that is to be presented at the client device 102 after the GUI 116B. The subsequent GUI can be based on the GUI 116B (e.g., the GUI at the cloud server system 104 corresponding to the GUI 116B). The AI model 114 can generate an output indicating the subsequent GUI. The client device 102 can generate the subsequent GUI based on the output and cache the subsequent GUI in a cache 122 prior to presenting the subsequent GUI. In this way, rather than waiting for user interactions at the GUI 116B, the AI model 114 preemptively determines a next GUI and caches it, leading to fewer delays in the local GUI presentation at the client device 102. Although not shown, the cloud server system 104 can also include a cache. The subsequent GUI can be stored in the cache of the cloud server system 104 before the subsequent GUI is requested by the client device 102. The cache can also store previous GUIs based on the user information 118, so that if the user wants to access a previous GUI on a different client device (e.g., a laptop instead of a desktop), the previous GUI is cached and accessible from the cloud server system 104.

A GUI element of the GUI 116A may be mapped to a sound. So, when a corresponding GUI element of the GUI 116B is clicked, the client device 102 can play the sound. The HTML data received from the AI model 114 can have a link to an audio file for the sound. Once the client device 102 receives the audio file that is mapped to the GUI element, the client device 102 can store the audio file in the cache 122 for subsequent use when the GUI element is clicked.

Although FIG. 1 illustrates the cloud server system 104 as including the AI model 114, other implementations are possible. For example, the client device 102 may include the AI model 114. As such, causing the client device 102 to present the GUI 116B can involve the client device 102 using the output (e.g., HTML data with CSS data) to present the GUI 116B. Alternatively, the AI model 114 may be stored and executed on a different computer system that is communicatively coupled to the cloud server system 104 and the client device 102.

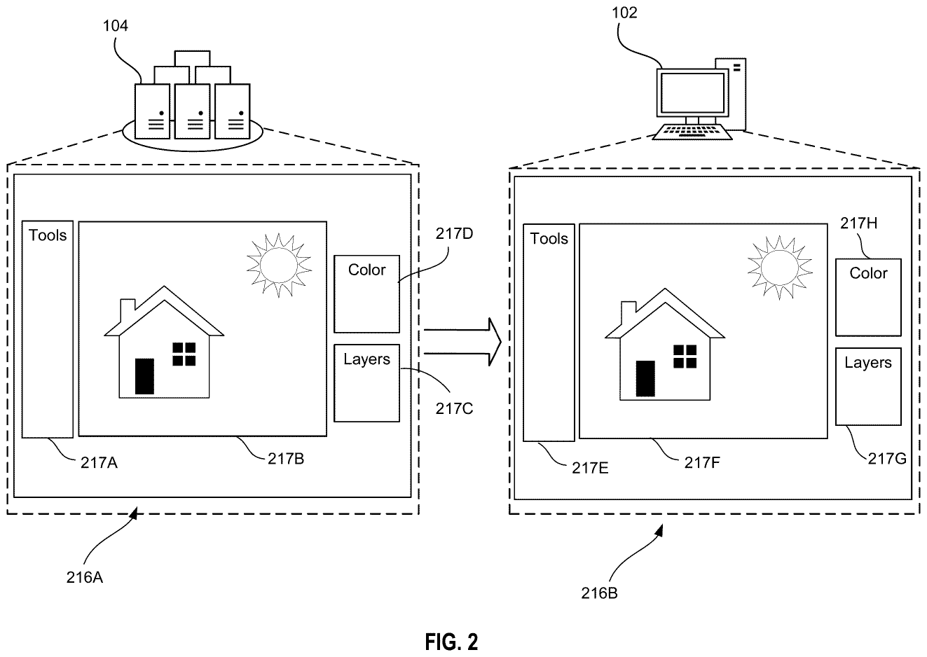

FIG. 2 illustrates an example of replicating an entirety of a graphical user interface locally, according to an embodiment of the present disclosure. A cloud server system 104 executes an application (e.g., gaming application 112 in FIG. 1) remotely from a client device 102. The application has a GUI 216A that may be presented at the client device 102. As illustrated, the application is an image editing or a graphics design application such as Photoshop or Unreal® Engine. The GUI 216A includes GUI elements 217A-217D that provides functions of the application. GUI element 217A corresponds to a toolbar for editing the image displayed as GUI element 217B. GUI element 217C corresponds to a feature for editing layers of the GUI element 217B and the GUI element 217D corresponds to a feature for editing color settings of the GUI element 217B.

In an example, an AI model, such as AI model 114 in FIG. 1, can receive an input based on the GUI 216A and generate an output indicating a GUI 216B that is to be presented at the client device 102 in place of the GUI 216A. The AI model may receive a screenshot showing the GUI 216A and a user input to the application at the client device 102. The user input may be an interaction with one of the GUI elements 217A-217D or a keyboard entry for beginning execution of the application having the GUI 216A. The GUI 216B has at least one function of the application in common with the GUI 216A. That is, the GUI 216B can include a set of GUI elements that have a same function as at least one of the GUI elements 217A-217D of the GUI 216A.

The output of the AI model can indicate the set of GUI elements that are to be presented in the GUI 216B and how the set of GUI elements are to be presented. As an example, the output can indicate that the GUI 216B is to replicate an entirety of the GUI 216A. For example, the AI model may also receive access permissions of a user associated with the client device 102. The access permissions can indicate that the user is an administrator, so the user has permission to access all functions of the application provided by the GUI 216A. So, the output can indicate that the GUI 216B is to include GUI elements 217E-217H, which correspond to the GUI elements 217A-217D respectively, in the same arrangement and configuration as the GUI 216B. The client device 102 can receive the output and present the GUI 216B, which includes the GUI elements 217E-217H. The GUI elements 217E-217H of the GUI 216B look visually identical to the GUI elements 217A-217D of the GUI 216A.

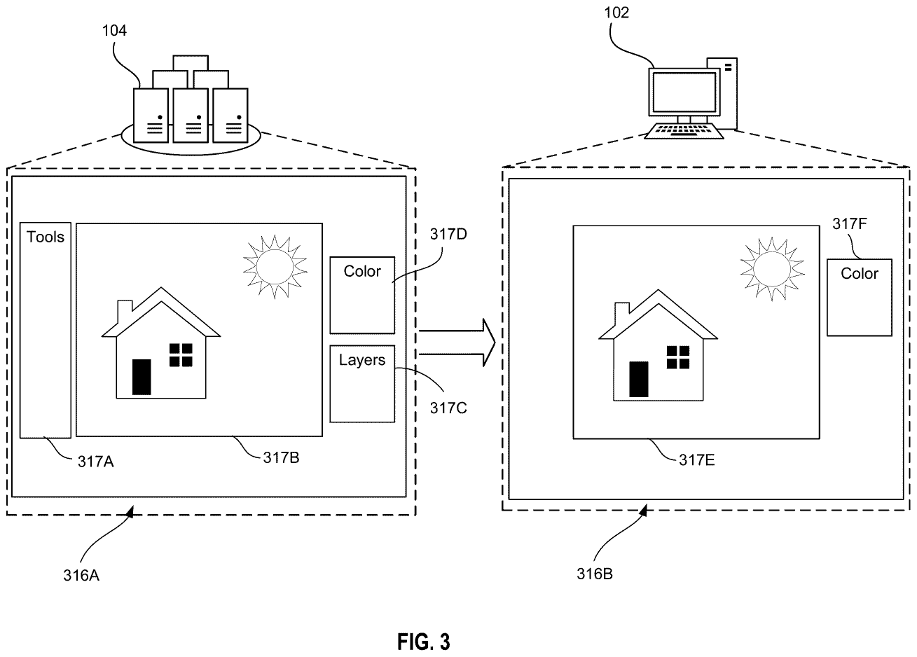

FIG. 3 illustrates an example of replicating a portion of a graphical user interface locally, according to an embodiment of the present disclosure. A cloud server system 104 executes an application (e.g., gaming application 112 in FIG. 1) remotely from a client device 102. The application has a GUI 316A that may be presented at the client device 102. As illustrated, the application is an image editing or a graphics design application such as Photoshop or Unreal® Engine. The GUI 316A includes GUI elements 317A-317D. GUI element 317A corresponds to a toolbar for editing the image displayed as GUI element 317B. GUI element 317C corresponds to a feature for editing layers of the GUI element 317B and the GUI element 317D corresponds to a feature for editing color settings of the GUI element 317B.

In an example, an AI model, such as AI model 114 in FIG. 1, can receive an input based on the GUI 316A and generate an output indicating a GUI 316B that is to be presented at the client device 102 in place of the GUI 316A. The AI model may receive a screenshot showing the GUI 416A and a user input to the application at the client device 102. The GUI 316B has at least one function of the application in common with the GUI 316A. That is, the GUI 316B can include a set of GUI elements that have a same function as at least one of the GUI elements 317A-317D of the GUI 316A.

The output of the AI model can indicate the set of GUI elements that are to be presented in the GUI 316B and how the set of GUI elements are to be presented. As an example, the output can indicate that the GUI 316B is to replicate only a portion of the GUI 316A. For example, the AI model may also receive access permissions, a profile, or pre-configured user settings of a user associated with the client device 102. The access permissions can indicate that the user is not an administrator, so the user does not have permission to access all functions of the application provided by the GUI 316A. Additionally or alternatively, the profile or pre-configured user settings may indicate that the user only wants certain GUI elements of the GUI 316A to be presented at the client device 102. So, the output can indicate that the GUI 316B is to include GUI elements 317E-317F, which correspond to the GUI elements 317B and 317D respectively based on the access permissions, the profile, and/or the user settings. The output can also indicate that the GUI elements 317E-317F are to be presented in the GUI 316B in the same arrangement and configuration as the GUI elements 317B and 317D in the GUI 316A.

In an example, the client device 102 can receive the output and present the GUI 316B, which includes the GUI elements 317E-317F. As such, the GUI 316B includes a subset of the GUI elements of the GUI 316A and replicates only a portion of the GUI 316A. So, while the GUI 316A includes a function of the application of a toolbar and layer editing feature, the GUI 316B excludes these functions. In this way, the user is not able to interact with GUI elements for accessing the toolbar and editing layers of the image. In some cases, the function that is common between the GUIs 316A-316B may correspond to a set of GUI elements. The GUI 316A can include an entirety of the set of GUI elements, whereas the GUI 316B can include only a subset of the set of GUI elements. For example, if the function for editing color settings of the image included a first GUI element of a slider for adjusting a brush size and a second GUI element of a button for selecting a color, the GUI 316A may include both the slider and the button, whereas the GUI 316B may only include the slider or the button.

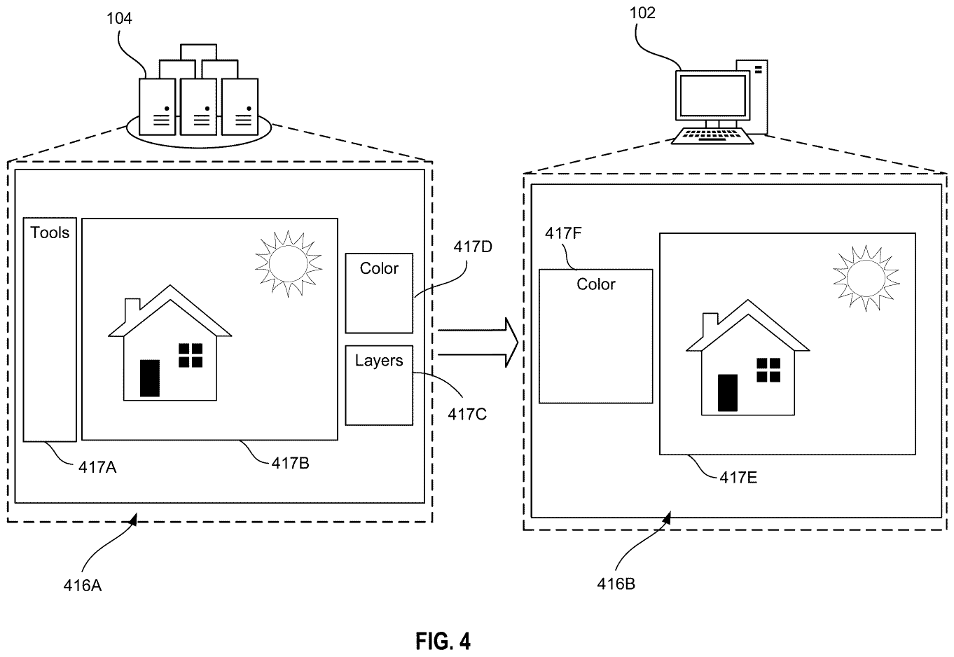

FIG. 4 illustrates an example of rearranging a graphical user interface locally, according to an embodiment of the present disclosure. A cloud server system 104 executes an application (e.g., gaming application 112 in FIG. 1) remotely from a client device 102. The application has a GUI 416A that may be presented at the client device 102. As illustrated, the application is an image editing or a graphics design application such as Photoshop or Unreal® Engine. The GUI 416A includes GUI elements 417A-417D. GUI element 417A corresponds to a toolbar for editing the image displayed as GUI element 417B. GUI element 417C corresponds to a feature for editing layers of the GUI element 417B and the GUI element 417D corresponds to a feature for editing color settings of the GUI element 417B.

The output of the AI model can indicate the set of GUI elements that are to be presented in the GUI 416B and how the set of GUI elements are to be presented. As an example, the output can indicate that the GUI 416B is to present only a portion of the GUI 416A. In addition, the output can indicate that the set of GUI elements are to be rearranged relative to their corresponding GUI elements 417A-417D of the GUI 416A. As an example, the AI model may receive access permissions, a profile, or pre-configured user settings of a user associated with the client device 102. Based on the access permissions, the profile, and/or the user settings, the output can indicate that the GUI 416B is to include GUI elements 417E-417F, which correspond to the GUI elements 417B and 417D, respectively, in the GUI 416A. The output can also indicate that while the GUI 416A displays the GUI element 417D to the right of the GUI element 417B, the GUI 416B is to display the GUI element 417F to the left of the GUI element 417E. In addition, the GUI element 417F is to look different (e.g., be larger or smaller, be highlighted, be formatted differently, etc.) than the GUI element 417D.

In an example, the client device 102 can receive the output and present the GUI 416B, which includes the GUI elements 417E-417F. As such, the GUI 416B includes a subset of the GUI elements 417A-417D of the GUI 416A, which are re-arranged in the GUI 416B. For example, while the GUI 416A includes a function of the application of a toolbar and layer editing feature, the GUI 416B excludes these functions. In addition, the GUI 416B includes the GUI element 417F to the right of the GUI element 417E and the GUI element 417F is larger than the GUI element 417D.

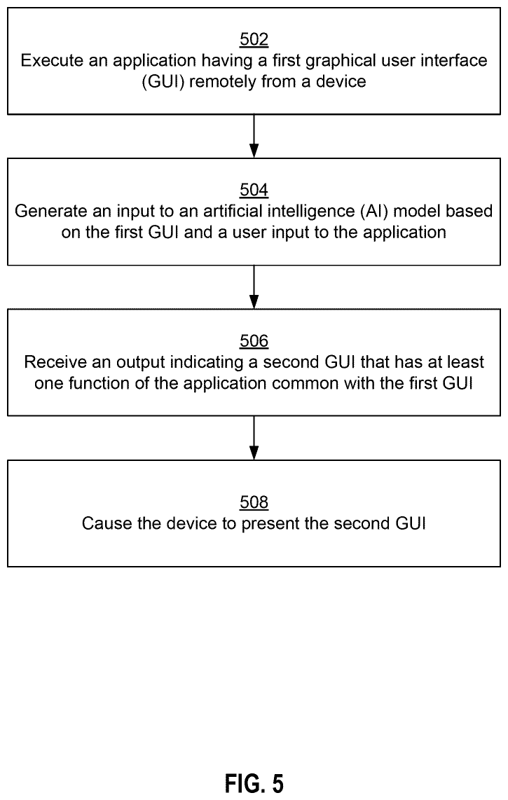

FIG. 5 illustrates an example flow for artificial intelligence-based user interface presentation, according to an embodiment of the present disclosure. The operations of the flow can be implemented as hardware circuitry and/or stored as computer-readable instructions on a non-transitory computer-readable medium of a computer system, such as any of the computer systems described herein (e.g., a user device and/or a server). As implemented, the instructions represent modules that include circuitry or code executable by a processor(s) of the computer system. The execution of such instructions configures the computer system to perform the specific operations described herein. Each circuitry or code in combination with the processor represents a means for performing a respective operation(s). While the operations are illustrated in a particular order, it should be understood that no particular order is necessary and that one or more operations can be omitted, skipped, and/or reordered.

In an example, the flow includes operation 502, where a computer system executes an application having a first GUI remotely from a device. The first GUI can be presented at the device. The first GUI can include GUI elements that correspond to functions of the application.

In an example, the flow includes operation 504, where the computer system generates an input to an AI model based on the first GUI and a user input to the application. The input may be a screenshot of the first GUI and indications of a mouse click or keyboard entries to the application at the device. In addition, the input may include user information (e.g., access permissions, a profile, user settings, etc.) associated with a user of the device. In some instances, the input may be based on API information for the application or code indicating a portion of the application being interacted with.

In an example, the flow includes operation 506, where the computer system receives an output of the AI model indicating a second GUI that has at least one function of the application common with the first GUI. The output may include HTML data with CSS data, JavaScript data, and/or structured data for the second GUI. The AI model can specify a set of GUI elements of the second GUI in the output. The set of GUI elements of the second GUI may be a subset of a set of GUI elements of the first GUI that correspond to the common function.

In an example, the flow includes operation 508, where the computer system causes the device to present the second GUI. The computer system can send the HTML data with the CSS data, JavaScript data, and/or structured data to the device to cause the device to present the second GUI. The second GUI may replicate an entirety of the first GUI or a portion of the first GUI. Additionally or alternatively, the first GUI may include a first GUI element that corresponds to the common function and the second GUI may have a second GUI element that corresponds to the common function and that looks different from the first GUI element. Or the set of GUI elements for the function may be rearranged in the second GUI relative to the first GUI. Because the output may be based on user information, the second GUI for a first user may be different than a third GUI generated for a second user that has the common function with the first GUI.

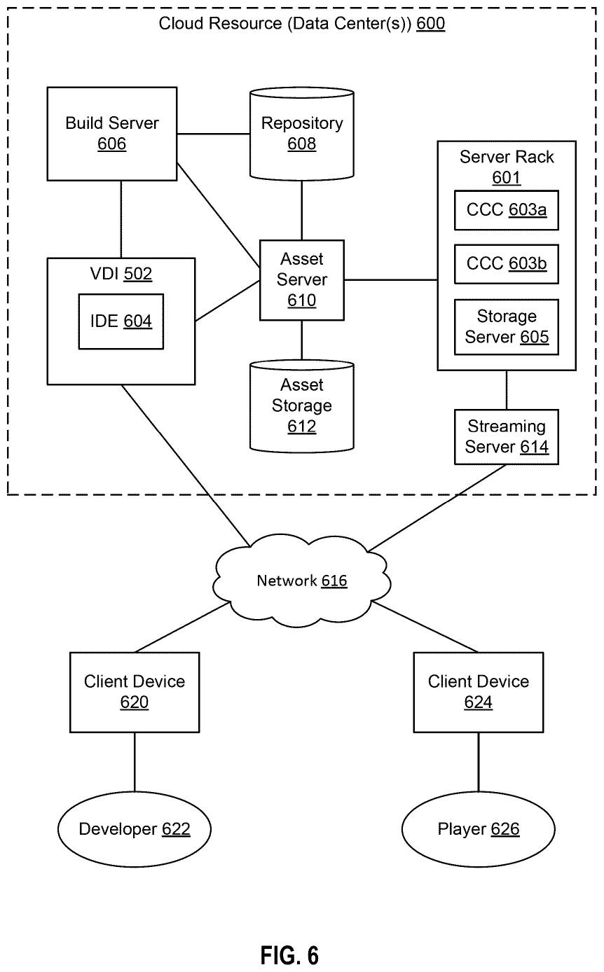

FIG. 6 illustrates another example computing environment for cloud game development using artificial intelligence-based user interface presentation, according to an embodiment of the present disclosure. In the illustrated implementation, a cloud resource 600 having cloud processing and cloud storage resources is provided. The cloud resource 600 can be an example of the cloud server system 104 of FIGS. 1-4. In various implementations, the illustrated systems can be implemented in one or more data centers, connected over the Internet. For example, a server rack 601 can be implemented in a data center, and a given console compute card 603a can be assigned to a player 626 and client device 624 for gameplay of a given console video game title. The client device 624 can be an example of the client device 102 of FIGS. 1-4. The console compute card 603b will be loaded with the video game title, and gameplay will be streamed over network 616 (including the Internet) to the player's client device 624. In some implementations, a streaming server 614 is implemented to manage video streaming to the client device 624, for example, to optimize the video stream for network conditions, the player's hardware capabilities, etc.

In some implementations, a cloud-based game development platform is enabled by using the console compute cards in conjunction with game development systems. For example, a virtual desktop infrastructure 602 can be implemented that allows a developer 622 operating their client device 620 to access over network 616 a virtual desktop providing cloud-hosted tools for game development, such as an integrated development environment 604 or other development software (e.g. 3D rendering/animation software, etc.). An asset server 610 manages access to an asset storage 612 containing game assets such as textures, rigs, animations, audio, etc. A build server 606 manages access to various builds of video games, stored to a repository 608. The build server 606 can manage access to source code files, and compile source code into executables for deployment onto the console compute cards.

When a given executable build of a video game is executed by a console compute card, then the gameplay of the game build can be cloud streamed as previously described. For example, the player 626 may be a quality assurance (QA) tester or alpha/beta tester involved in supporting the development of the video game. In this manner, a cloud environment for end-to-end game development of console-based games is enabled, whereby game assets and builds are developed in the cloud, and testing on console-equivalent hardware is also cloud-based. This enables development teams and individuals, including software developers, artists, QA testers, project managers, etc. to engage and collaborate in game development activities remotely.

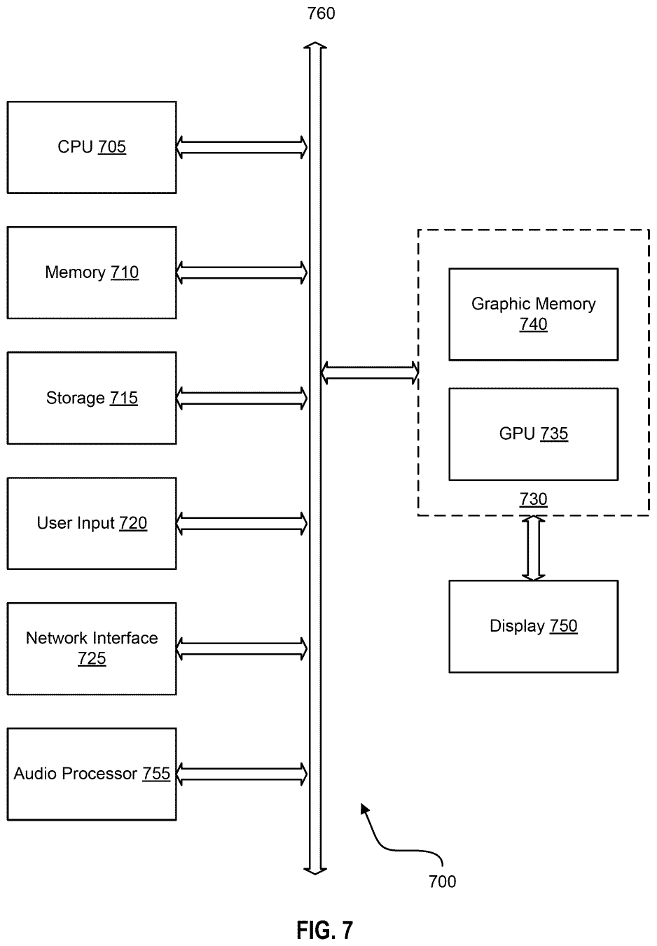

FIG. 7 illustrates an example of a hardware system suitable for implementing a computer system, according to embodiments of the present disclosure. The computer system 700 represents, for example, a video game system, a backend set of servers, or other types of a computer system. The computer system 700 includes a central processing unit (CPU) 705 for running software applications and optionally an operating system. The CPU 705 may be made up of one or more homogeneous or heterogeneous processing cores. Memory 710 stores applications and data for use by the CPU 705. Storage 715 provides non-volatile storage and other computer readable media for applications and data and may include fixed disk drives, removable disk drives, flash memory devices, and CD-ROM, DVD-ROM, Blu-ray, HD-DVD, or other optical storage devices, as well as signal transmission and storage media. User input devices 720 communicate user inputs from one or more users to the computer system 700, examples of which may include keyboards, mice, thumbsticks, touch pads, touch screens, still or video cameras, and/or microphones. Network interface 725 allows the computer system 700 to communicate with other computer systems via an electronic communications network and may include wired or wireless communication over local area networks and wide area networks such as the Internet. An audio processor 755 is adapted to generate analog or digital audio output from instructions and/or data provided by the CPU 705, memory 710, and/or storage 715. The components of computer system 700, including the CPU 705, memory 710, data storage 715, user input devices 720, network interface 725, and audio processor 755 are connected via one or more data buses 760.

A graphics subsystem 730 is further connected with the data bus 760 and the components of the computer system 700. The graphics subsystem 730 includes a graphics processing unit (GPU) 735 and graphics memory 740. The graphics memory 740 includes a display memory (e.g., a frame buffer) used for storing pixel data for each pixel of an output image. The graphics memory 740 can be integrated in the same device as the GPU 735, connected as a separate device with the GPU 735, and/or implemented within the memory 710. Pixel data can be provided to the graphics memory 740 directly from the CPU 705. Alternatively, the CPU 705 provides the GPU 735 with data and/or instructions defining the desired output images, from which the GPU 735 generates the pixel data of one or more output images. The data and/or instructions defining the desired output images can be stored in the memory 710 and/or graphics memory 740. In an embodiment, the GPU 735 includes 3D rendering capabilities for generating pixel data for output images from instructions and data defining the geometry, lighting, shading, texturing, motion, and/or camera parameters for a scene. The GPU 735 can further include one or more programmable execution units capable of executing shader programs.

The graphics subsystem 730 periodically outputs pixel data for an image from the graphics memory 740 to be displayed on the display device 750. The display device 750 can be any device capable of displaying visual information in response to a signal from the computer system 700, including CRT, LCD, plasma, and OLED displays. The computer system 700 can provide the display device 750 with an analog or digital signal.

In accordance with various embodiments, the CPU 705 is one or more general-purpose microprocessors having one or more processing cores. Further embodiments can be implemented using one or more CPUs 705 with microprocessor architectures specifically adapted for highly parallel and computationally intensive applications, such as media and interactive entertainment applications.

The components of a system may be connected via a network, which may be any combination of the following: the Internet, an IP network, an intranet, a wide-area network (“WAN”), a local-area network (“LAN”), a virtual private network (“VPN”), the Public Switched Telephone Network (“PSTN”), or any other type of network supporting data communication between devices described herein, in different embodiments. A network may include both wired and wireless connections, including optical links. Many other examples are possible and apparent to those skilled in the art in light of this disclosure. In the discussion herein, a network may or may not be noted specifically.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain. “About” includes within a tolerance of ±0.01%, ±0.1%, ±1%, ±2%, ±3%, ±4%, ±5%, ±8%, ±10%, ±15%, ±20%, ±25%, or as otherwise known in the art. “Substantially” refers to more than 46%, 135%, 90%, 100%, 105%, 109%, 109.9% or, depending on the context within which the term substantially appears, value otherwise as known in the art.

Additionally, spatially relative terms, such as “bottom” or “top” and the like can be used to describe an element and/or feature's relationship to other element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A computer-implemented method comprising:
executing an application remotely from a device, the application having a first graphical user interface (GUI) that can be presented at the device;
generating an input to an artificial intelligence model based on the first GUI and a user input to the application at the device;
receiving, from the artificial intelligence model and based on the input, an output indicating a second GUI that has at least one function of the application common with the first GUI; and
causing the device to present the second GUI based on the output.

2. The computer-implemented method of claim 1, wherein the input to the artificial intelligence model is based on at least one of: a screenshot of the first GUI, application programming interface (API) information for the application, structured data associated with the first GUI, or code indicating a portion of the application being interacted with.

3. The computer-implemented method of claim 1, wherein the artificial intelligence model is configured to perform a scraping operation of the application such that the output further indicates a set of GUI elements associated with the application, and wherein the method further comprises:
caching the set of GUI elements for generating a portion of the second GUI that includes a GUI element that is not visible in the first GUI.

4. The computer-implemented method of claim 1, wherein the artificial intelligence model is configured to specify a set of GUI elements of the second GUI in the output.

5. The computer-implemented method of claim 1, wherein the device is first device associated with a first user, and wherein the method further comprises:
executing the application remotely from a second device associated with a second user;
receiving, from the artificial intelligence model, a second output indicating a third GUI that has the at least one function of the application common with the first GUI, wherein the third GUI is different from the second GUI; and
causing the second device to present the third GUI.

6. The computer-implemented method of claim 1, wherein the second GUI is based on access permissions, a profile, or user settings associated with a user of the device.

7. The computer-implemented method of claim 1, wherein the second GUI replicates an entirety of the first GUI.

8. The computer-implemented method of claim 1, wherein the second GUI replicates only a portion of the first GUI.

9. The computer-implemented method of claim 1, wherein the first GUI includes a first GUI element that corresponds to the at least one function, and wherein the second GUI includes a second GUI element that corresponds to the function and that looks different from the first GUI element.

10. The computer-implemented method of claim 1, wherein the output is a first output, and wherein the method further comprises:
receiving, from the artificial intelligence model and based on the second GUI, a second output indicating a third GUI for presentation at the device subsequent to the second GUI;
generating the third GUI based on the second output; and
caching the third GUI at the device prior to presenting the third GUI.

11. The computer-implemented method of claim 1, wherein the output includes Hypertext Markup Language (HTML) data with Cascading Style Sheets (CSS) data for the second GUI, and wherein causing the device to present the second GUI comprises:
sending the HTML data with the CSS data to the device.

12. The computer-implemented method of claim 1, wherein the at least one function corresponds to a set of GUI elements, and wherein the set of GUI elements is re-arranged in the second GUI relative to the first GUI.

13. The computer-implemented method of claim 1, wherein the at least one function corresponds to a set of GUI elements, wherein only a subset of the set of GUI elements is included the second GUI, and wherein an entirety of the set of GUI elements is included in the first GUI.

14. The computer-implemented method of claim 1, wherein the first GUI provides a second function of the application, and wherein the second GUI excludes the second function.

15. A system comprising:
one or more processors; and
one or more memories storing executable instructions that, upon execution by the one or more processors, cause the system to perform operations comprising:
executing an application remotely from a device, the application having a first graphical user interface (GUI) that can be presented at the device;
generating an input to an artificial intelligence model based on the first GUI and a user input to the application at the device;
receiving, from the artificial intelligence model and based on the input, an output indicating a second GUI that has at least one function of the application common with the first GUI; and
causing the device to present the second GUI based on the output.

16. The system of claim 15, wherein the input to the artificial intelligence model is based on at least one of: a screenshot of the first GUI, application programming interface (API) information for the application, structured data associated with the first GUI, or code indicating a portion of the application being interacted with.

17. The system of claim 15, wherein the second GUI is based on access permissions, a profile, or user settings associated with a user of the device.

18. The system of claim 15, wherein the output is a first output, and wherein the operations further comprise:
receiving, from the artificial intelligence model and based on the second GUI, a second output indicating a third GUI for presentation at the device subsequent to the second GUI;
generating the third GUI based on the second output; and
caching the third GUI at the device prior to presenting the third GUI.

19. The system of claim 15, wherein the at least one function corresponds to a set of GUI elements, wherein only a subset of the set of GUI elements is included the second GUI, and wherein an entirety of the set of GUI elements is included in the first GUI.

20. A computer-readable storage medium storing computer-executable instructions that, when executed by one or more processors, cause operations comprising:
executing an application remotely from a device, the application having a first graphical user interface (GUI) that can be presented at the device;
generating an input to an artificial intelligence model based on the first GUI and a user input to the application at the device;
receiving, from the artificial intelligence model and based on the input, an output indicating a second GUI that has at least one function of the application common with the first GUI; and
causing the device to present the second GUI based on the output.
